(19) United States
(12) Patent Application Publication
(10) Pub. No.: US 2005/0206725 A1
(43) Pub. Date: Sep. 22, 2005

(54) System and method for viewing mini-bar status

(76) Inventors: Duane W. Buckingham, Old Lyme, CT (US); Philipp A. Roosli, Niantic, CT (US); Richard N. Quirino, East Lyme, CT (US)

Correspondence Address: CANTOR COLBURN, LLP, 55 GRIFFIN ROAD SOUTH, BLOOMFIELD, CT, 06002, US

(21) Appl. No.: 11/051,451

(22) Filed: Feb. 4, 2005

Related U.S. Application Data
(60) Provisional application No. 60/542,432, filed on Feb. 5, 2004.

(51) Int. Cl. H04N 7/18

(52) U.S. Cl. 348/143; 340/5.92; 340/5.61

(57) ABSTRACT

A mini-bar and a system and a method of monitoring activity of a mini-bar where the mini-bar includes an imaging device disposed for acquiring an image of an interior of the mini-bar.

### CROSS REFERENCE TO RELATED APPLICATION

This patent application claims priority to a provisional application that was filed on Feb. 5, 2004, Ser. No. 60/542,432, the entire contents of which are incorporated herein by reference.

### BACKGROUND OF THE INVENTION

The invention relates generally to monitoring systems and, more particularly, to a system for monitoring the status of a mini-bar.

Multi-unit buildings such as hotels, motels, inns, and the like, offer a variety of services and facilities for the convenience of their guests, such as a mini-bar. A mini-bar is a convenient store of goods within each room, usually within a refrigerator, that can be accessed by the occupant at his or her discretion. Typically, the mini-bar is re-stocked after the occupant checks out, and the occupant is billed for the items that he or she consumed. The mini-bar is also often checked on a daily basis, often while the room is occupied, for re-stocking. This can be annoying and inconvenient for the occupant.

Monitoring devices and systems for mini-bars are known. One such device is a door switch that detects an opening of the door of a mini-bar. Door switches only provide information that the mini-bar door has been opened. They fail to provide any indication that an item from the mini-bar has actually been removed. Accordingly, if the switch indicates that the mini-bar has been opened then housekeeping will check the mini-bar for re-stocking. However, as is often the case, no item has been removed from the mini-bar. Another such monitoring system not only indicates when a mini-bar has been accessed but also indicates that consumable items have been removed. Such mini-bars track items by, e.g., pressure sensitive switches or infrared light barriers. These product-sensor type mini-bars carry the disadvantage that they are unforgiving to the user—a removed and returned product is registered as consumed. These product sensors tend to be unreliable as the number of sensors per mini-bar can be very high. One example of a mini-bar monitoring system is commercially available from Bartech Systems Corporation of Millersville, Md. Further, removed and returned items can lead to awkward situations at the front desk during checkout to reconcile the actual consumption.

### SUMMARY OF THE INVENTION

The above discussed and other drawbacks and deficiencies are overcome or alleviated by an exemplary system and method for viewing mini-bar status.

In one aspect of the invention, a mini-bar includes an imaging device disposed for acquiring an image of an interior of the mini-bar.

In another aspect of the invention, a system for monitoring activity of a mini-bar in a room of a multi-unit building, comprises an imaging device disposed for acquiring an image of an interior of the mini-bar, the imaging device configured to generate image data indicative of the image, and a display device receptive to the image data for displaying the image, the display device configured for viewing the image external to the mini-bar.

In still another aspect of the invention a method for monitoring activity of a mini-bar in a room of a multi-unit building comprises acquiring an image of an interior of the mini-bar, and displaying the image.

The above discussed and other features and advantages of the present invention will be appreciated and understood by those skilled in the art from the following detailed description and drawings.

### BRIEF DESCRIPTION OF THE DRAWINGS

Referring now to the drawings wherein like elements are numbered alike in the several FIGURES:

FIG. 1 is a top sectional view of an exemplary room;

FIG. 2A is a perspective view of a mini-bar in accordance with the present invention;

FIG. 2B is an interior view of the door of the mini-bar of FIG. 2A;

FIG. 3 is an interior view of the mini-bar without the door, in accordance with another embodiment of the invention;

FIG. 4 is a schematic block diagram of a controller for the mini-bar;

FIG. 5 is a schematic block diagram of a gateway module, in accordance with an embodiment of the present invention;

FIG. 6 is a front view of an IR transceiver plate assembly of FIG. 1;

FIG. 7 is a front view of a display plate assembly of FIG. 1; and

FIG. 8 is a centralized occupant room control system or network.

### DETAILED DESCRIPTION OF THE INVENTION

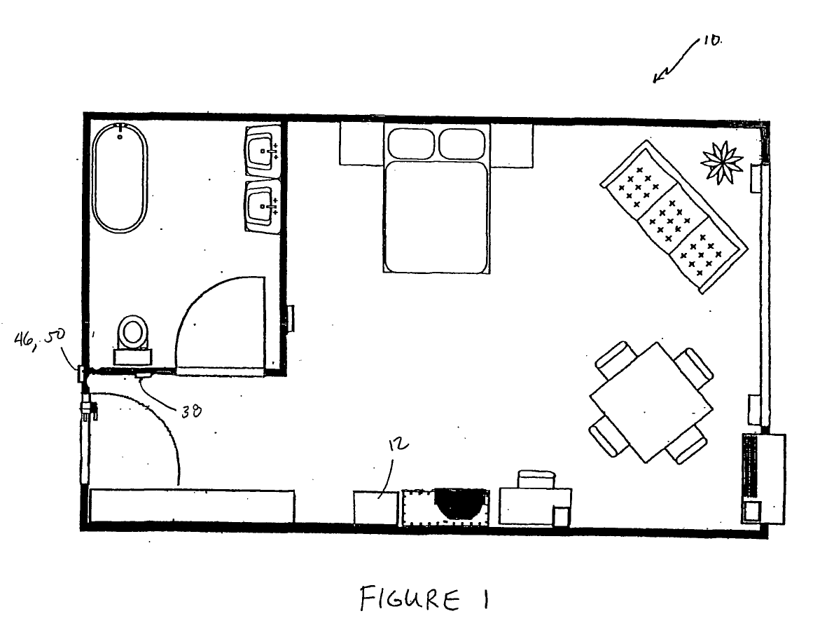

FIG. 1 shows an exemplary room 10 of a multi-unit building, the room including a number of devices enhancing the security and convenience of occupants, and the operating efficiency of the staff or the multi-unit building. One such device is a min-bar 12. Multi-unit building includes hotels, motels, inns, dormitories, cooperatives, apartments, condominiums, and the like, that offer a variety of services and facilities for the convenience of their guests or residents (occupants).

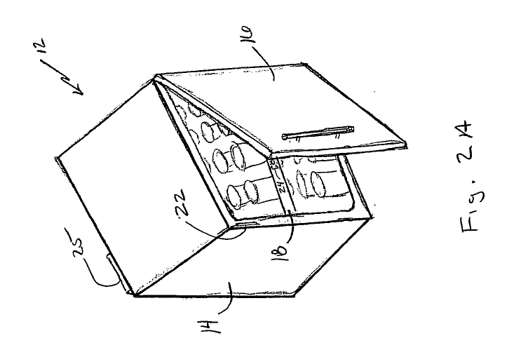

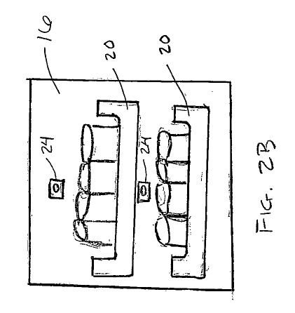

Referring to FIGS. 2A and B, a conventional mini-bar 12 comprises a housing 14 (which is typically a refrigerated housing, but it is within the scope of the present invention that the housing is not refrigerated, as such is not required with many consumable items) and a door 16. Items are stored within the housing, which typically includes at least one shelf 18 to maximize storage therein. Additional shelves 20 at the inside of the door 16 also provide storage. In the present invention, a door switch 22 is provided to detect the state, i.e., an open state or a closed state, of the door 16. One example of a mini-bar door switch is model S241 or S541 door switch commercially available from Inncom International, Inc, and described in U.S. Pat. No. 6,832,072 which is herein incorporated by reference in its entirety. Cameras 24 are positioned on the inside of the door 16 to capture an image of the items at each level of the mini-bar and at the shelf to capture an image of the items on the door shelves 20. A mechanical shutter may be employed over the lens of the camera to protect the lens from condensation and guest tampering.

It is within the scope of the present invention that any number of cameras may be used, including a single camera, and that such camera(s) may be arranged at any desired location(s) and disposition(s) (e.g., positioned on an interior side, back, top, or bottom surface of the mini-bar housing 14). Further, the cameras may employ a wide-angle lens or any other suitable lens to capture the images. What is important is that the camera(s) be positioned to capture one or more images of the items. It is preferred that the cameras be triggered to capture images upon closure of the door 16, as detected by switch 22. This may require a flash or in the case of mini-bars with an interior light, a delay in turning the light off to allow the cameras to capture images. The cameras may be triggered sequentially or simultaneously. The camera being controlled (and powered) by a controller 25, which could be mounted at the exterior back of the mini-bar or any other suitable location. A still-picture camera may be preferred, as such is typically less expensive than a continuous camera (although use of a continuous camera is within the scope of the invention). Further, limiting imaging to when the door is closed will eliminate any concerns regarding privacy, as it may not be desirable to capture images of an occupied room.

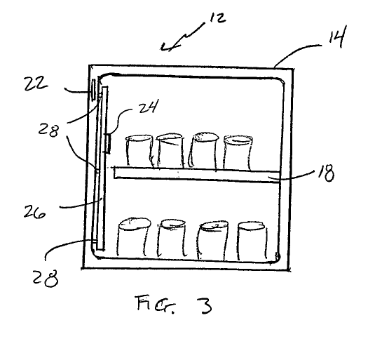

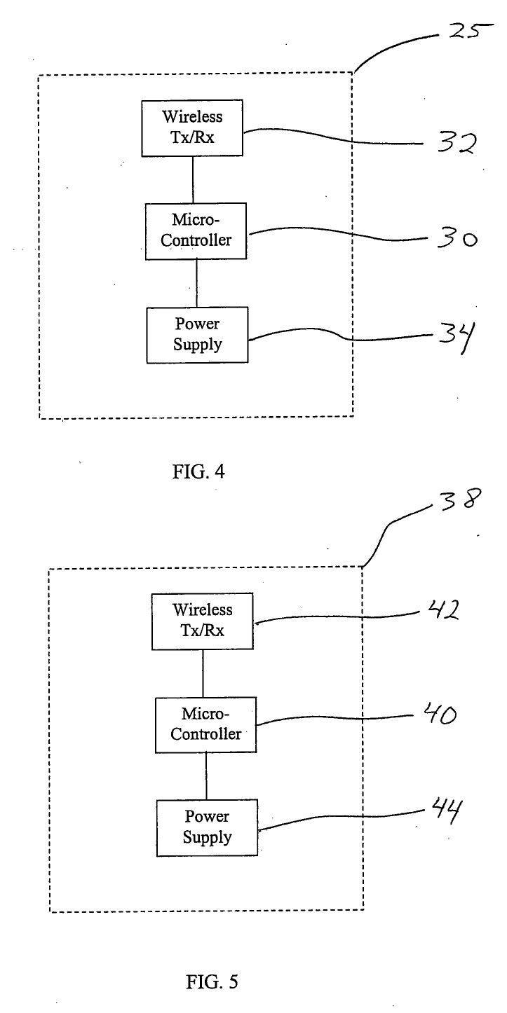

Referring to FIG. 3, camera 24 is mounted on a track 26 at an inside surface of the housing 14 or door 16 (FIG. 2A, 2B) to allow the camera 24 to move up and down to allow for imaging of all of the items in the mini-bar 12. Additional tracks 28 may be provided, when mounted inside of the housing 14, to allow track 26 (and thereby camera 24) to move backward and forward within the housing 14. Use of tracks 28 will require further accommodations within the mini-bar 12. More specifically, the shelf 18 may require shortening (as shown) to provide sufficient clearance, as will be readily apparent to one skilled in the art. The camera 24 is driven along track 26 and track 26 is driven along tracks 28 by miniature electric motors (continuous or step), with power being provided from a controller 25 (FIG. 4). The camera is preferably driven to generate a series of sequential images.

Further, the camera 24 may be pivotally mounted, in any of the exemplary embodiments, with the position being controlled by a miniature electric motor (continuous or step), with power being provided from controller 25.

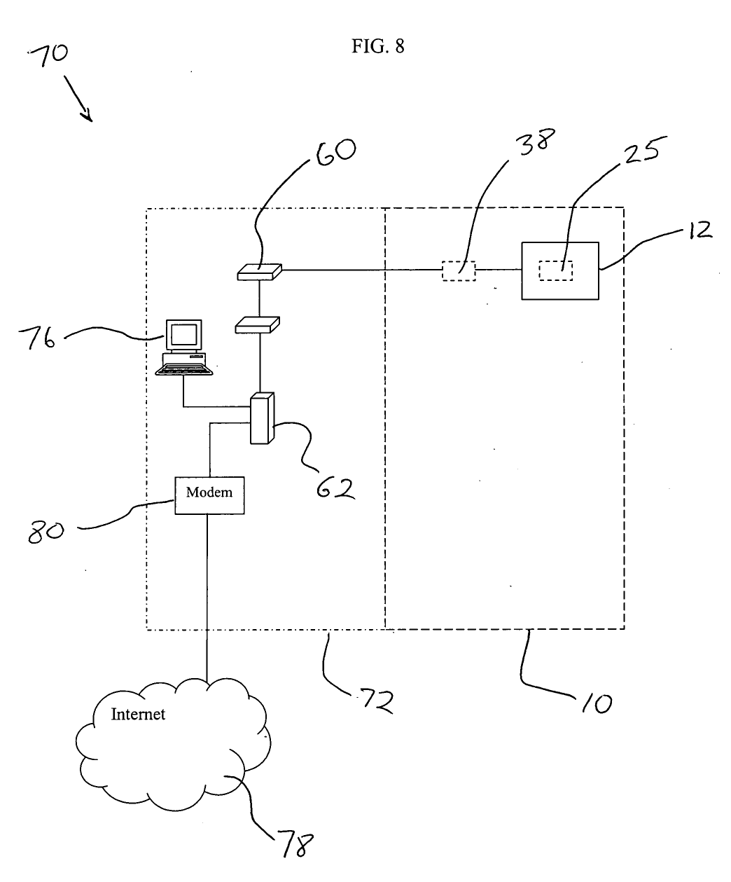

Referring now to FIG. 4, a schematic block diagram of the controller 25 is generally shown. Controller 25 includes a micro controller 30 having associated memory, i.e., random access memory (working memory) and non-volatile memory (boot-code and programming instructions) and an interface for providing data communication over a Local Area Network (LAN). Controller 25 communicates over the LAN in a suitable protocol (e.g., TCP/IP, UDP/IP, Inncom International, Inc's proprietary P5 Protocol, Wi-Fi, ZigBee, 802.15.4, Bluetooth, etc.) with a central floor switch 60 (FIG. 8) for the floor or area where the room is located, which is in communication with a central server or processor 62 (FIG. 8), or directly with the central server 62. Controller 25 interfaces with the LAN by way of conventional wiring or wireless communication configurations. With wireless communications a wireless transceiver 32 is connected to micro controller 30 for providing wireless (e.g., IR (infrared), RF (radio frequency), U/S (ultrasonic), etc.) communication.

Wireless IR communication may utilize, for example, the protocol described in U.S. Pat. No. 5,128,792, which is incorporated herein by reference. Digital iterative gain control such as described in U.S. patent application Ser. No. 10/631,457, entitled Digital Iterative Gain Control, filed Jul. 30, 2003, which is incorporated herein by reference, may also be utilized. Further, the infrared communication protocol may be the IR5 infrared protocol described in the above-referenced applications. Other infrared communication protocols may include IrDA, or the like.

Wireless RF communication may utilize, for example, 802.11b radio frequency protocol, WI-FI, Bluetooth, ZigBee, 802.15.4, or any other suitable protocol.

Wired communication may comprise any conventional wiring, (e.g., twisted-pair not shown). Alternatively, the controller 25 could be connected to electrical or telephone wiring for providing communication over such, as communication configurations and protocols on such wiring are known.

Controller 25 is powered by a power regulator or supply 34 connected to line power, although controller 25 may be directly powered from an appropriate low voltage line (whereby the power regulator 34 could be eliminated). Low voltage DC power could be obtained from a low voltage DC electric bus commonly found in such multi-unit buildings or could be generated by a AC-to-DC converter located within a wall or ceiling of the building. The converter would be powered directly from electrical wiring of the multi-unit building. While a micro controller is described as having integrated elements, it will be appreciated that the memory and interface could be discrete elements, as is well known in the art. Also, the micro controller may alternatively comprise a microprocessor, a programmable logic device (PLD), a programmable logic array (PLA), a programmable logic controller (PLC) or other suitable device, generically referred to herein as a processor, each being well known in the art and the configuration of each being readily apparent to one skilled in the art.

Micro controller 30 of controller 25, upon detection by door switch 22 of opening and closing of the mini-bar door, initiates a picture(s). This may be a single picture or a series of pictures when the camera is mounted for scanning on the aforementioned tracks or multiple cameras are employed. The data for the picture(s) is then transmitted to the central server 62 (FIG. 8) for processing. Controller 25 may also control a light in the mini-bar to be on while images are being acquired. This light may be the light internal to the mini-bar (as are commonly found in conventional mini-bars) or a light mounted at the interior of the mini-bar (which would be powered by the controller).

Referring to FIGS. 1 and 5, a gateway module 38 may be employed within the room 10. Gateway module 38 includes a micro controller 40 having associated memory, i.e., random access memory (working memory) and non-volatile memory (boot-code and programming instructions) and an interface for providing data communication with a central floor switch 60 (FIG. 8). A wireless transceiver 42 is connected to micro controller 40 for providing wireless (IR or RF) communication. Gateway module 38 is powered by a power regulator or supply 44 connected to line power, although gateway module 38 may be directly powered from an appropriate low voltage line (whereby the power regulator 44 could be eliminated). While a micro controller is described as having integrated elements, it will be appreciated that the memory and interface could be discrete elements, as is well known in the art. Also, micro controller may alternatively comprise a microprocessor, a programmable logic device (PLD), a programmable logic array (PLA), a programmable logic controller (PLC) or other suitable device, generically referred to herein as a processor, each being well known in the art and the configuration of each being readily apparent to one skilled in the art.

Gateway module 38 communicates over the LAN in a suitable protocol (e.g., TCP/IP or UDP/IP, Inncom International, Inc's proprietary P5 Protocol, Wi-Fi, ZigBee, 802.15.4, Bluetooth, etc.) that is compatible with the central floor switch 60 (FIG. 8), or directly or wirelessly via wireless mesh-net backbone and/or over an aforesaid suitable protocol to the central server 62. Gateway module 38 interfaces with the LAN by way of conventional wiring or wireless communication configurations in a suitable protocol. Gateway module 38 communicates with the controller 25 via wired or wireless communication in a suitable protocol.

Wireless IR communication may utilize, for example, the protocol described in U.S. Pat. No. 5,128,792, which is incorporated herein by reference. Digital iterative gain control such as described in U.S. patent application Ser. No. 10/631,457, entitled Digital Iterative Gain Control, filed Jul. 30, 2003, which is incorporated herein by reference, may also be utilized. Further, the infrared communication protocol may be the IR5 infrared protocol described in the above-referenced applications. Other infrared communication protocols may include IrDA, or the like.

Wireless RF communication may utilize, for example, 802.11b radio frequency protocol, WI-FI, Bluetooth, ZigBee, 802.15.4 or any other suitable protocol.

Wired communication may comprise any conventional wiring, (e.g., twisted-pair not shown). Alternatively, the gateway could be connected to electrical or telephone wiring for providing communication over such, as communication configurations and protocols on such wiring are known.

Typically, the mini-bar is re-stocked after the occupant checks out, and the occupant is billed for the items that he or she consumed. Server 62 (FIG. 8) processes the image data for review by staff, with each image being time and date stamped. These images may displayed at any computer terminal or display 76 configured to receive the images. Server 62 (FIG. 8) executes programming instructions to determine if restocking of the mini-bar is required, e.g., the mini-bar door has been opened and the collected images indicate that items may have been removed. Thereby providing staff with a current ‘slide-show’ of the mini-bars, i.e., a virtual walk-through.

Known image enhancement/processing techniques may be employed to add a visual-difference picture, highlighting the picture areas where actual changes are recognizable (for ease of picture interpretation). Also, a second set of images can be obtained in the IR domain for enhanced evaluation/tamper checks. For example, temperature changes may indicate that an item has been removed and replaced or that a liquid has been refilled to avoid a charge.

Displaying a sequence of pictures at a front desk terminal may assist the front desk clerk at time of checkout to reconcile consumption disputes. For example, the image at 9:00 a.m. shows a particular item in the mini-bar and an image at 10:00 a.m. shows that the particular item is no longer in the mini-bar, whereby it must have been removed when the mini-bar was opened causing the latter picture to be taken.

In an alternate embodiment, the server 62 (FIG. 8) executes programming instructions to process the image data with a heuristic image interpretation for automated tracking of items in the mini-bar. From this heuristic image interpretation the server can generate a report of items in a mini-bar and/or items removed from the mini-bar. This report can be printed, displayed, and/or archived. Once the server determines that an item has been removed it can also generate a charge on the guest's account for the item through an interface between the central server 62 and a point-of-sale system. This would eliminate any staff member review of images to determine mini-bar status, as the process would be fully automated. The staff member would only have to review images in the event of a detected anomaly or dispute with a guest, as to which item(s) were consumed/removed from the mini-bar.

With RF wireless communications, images can be transmitted and received by a personal digital assistant (PDA) or other portable communication device, which supports RF communication, carried by a staff member. This allows the staff member to visually inspect the mini-bar without entering the room, by viewing images or a report. More specifically, the staff member sends a command from the PDA to the controller 25 to collect image data and/or reporting data (which may be acquired at that time or previously stored). This data is collected and sent to the PDA, where the inquiring staff member views images and/or a report. Images are preferably only acquired when the mini-bar door is closed, in order to protect the privacy of the occupants/guests.

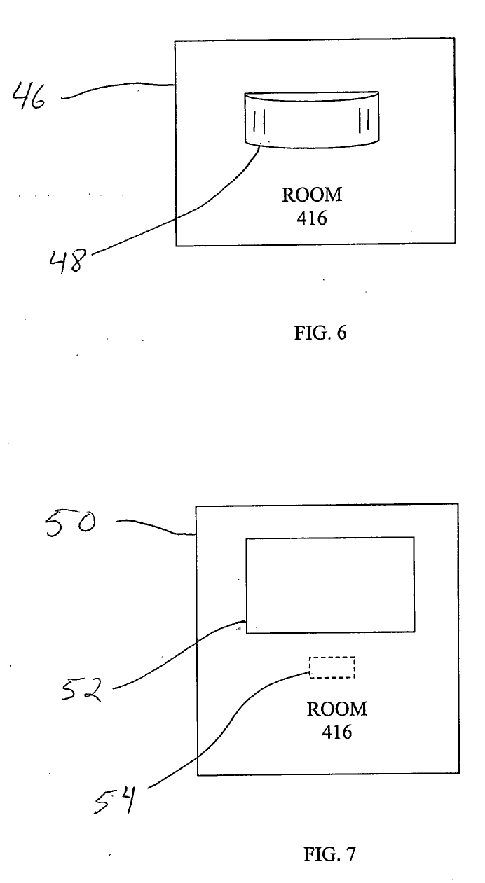

With IR wireless communication a transceiver is used. Referring to FIGS. 1 and 6, an IR transceiver plate assembly 46 is generally shown, which includes an IR transceiver 48 and may also include a room number thereon. The IR transceiver is of the type described hereinbefore with respect to the controller 25 and the gateway module 38 for wireless IR communication. This would allow for wireless IR communication between the IR transceiver 48 and a PDA or other portable communication device carried by a staff member. The IR transceiver 48 may be hard wired or wirelessly connected to the controller 25 or the gateway module 38 for communication as described hereinbefore. This allows the staff member to visually inspect the mini-bar without entering the room, by viewing images or a report. More specifically, the staff member sends a command from the PDA to the IR transceiver 48, thereby to the controller 25 to collect image data and/or reporting data (which may be acquired at that time or previously stored). This data is collected and sent through the IR transceiver 48 to the PDA, where the inquiring staff member views images and/or a report. Again, images are preferably only acquired when the mini-bar door is closed, in order to protect the privacy of the occupants/guests.

Referring to FIGS. 1 and 7, a display plate assembly 50 is generally shown, which includes a flat panel display 52 and may also include a room number thereon. Display plate assembly 50 includes a hidden switch 54, which may be either mechanically, magnetically, or wireless (RF or optically, e.g., IR) triggered or queried, for activating the display 52. Hidden switch 54 is mechanically activated when a staff member activates hidden switch 54 by depressing it. Hidden switch 54 can also be magnetically activated when the staff member activates the hidden switch 54 by placing a small, handheld magnet (not shown) near the hidden switch. This allows the staff member to visually inspect the mini-bar without entering the room, by viewing images or a report. More specifically, the staff member activates the switch causing a command to be sent to the controller 25 to collect image data and/or reporting data (which may be acquired at that time or previously stored). This data is collected and sent to the display 52, where the inquiring staff member views images and/or a report. Again, images are preferably only acquired when the mini-bar door is closed, in order to protect the privacy of the occupants/guests.

Display plate assembly 50 may be hardwired to the controller 25 or the gateway module 38 for communication, as described hereinbefore, for receiving the image data and/or reporting data for display. Display plate assembly 50 may alternatively include a micro controller and a wireless transceiver (as described hereinbefore with respect to the controller 25 and the gateway module 38) for RF wireless communication. This would allow for RF wireless communication between the display plate assembly 50 and the controller 25, directly or through the gateway module 38. The display plate assembly 50 is typically mounted at the wall in close proximity to the door of the room.

The system of the invention may additionally or alternatively include a display device disposed within the room 10 by which an occupant of the room may access images of the interior of the mini-bar provided by the camera 24 and/or data or information relating to the images. The occupant display device may be any device which is suitable for displaying images, text, graphics, etc., such as a CRT monitor, an LED panel, etc. For example, the occupant display device may be a device such as the Guestroom Digital Assistant (GDA-700) commercially available from Inncom International, Inc. Alternatively, the occupant display device may comprise a television disposed in the room. Further alternatively, the occupant display device may comprise a monitor, display panel, or the like disposed on the mini-bar. The occupant display device is disposed communicatively within the system 70 (FIG. 8) so as to receive the images and/or image information and image data from the micro controller 25, the gateway 38, the central server 62, or the internet 78 by way of any wired or wireless modes described herein. In an exemplary embodiment, the occupant display device may be configured to display information concerning items removed from or remaining in the mini-bar. Such information may comprise an itemized listing of removed items and/or a monetary amount(s) corresponding to the removed items and/or an itemized listing of items remaining in the mini-bar and/or a monetary amount(s) corresponding to the remaining items and/or any other information pertaining to the status of the mini-bar.

It is within the scope of the present invention, that micro controller 30 of controller 25 perform much of the processing described herein as being performed at the server 62. In such an embodiment micro controller 30 has sufficient processing power to accomplish the desired tasks. For example, micro controller 30 may process the image data with a heuristic image interpretation for automated tracking of items in the mini-bar, as described hereinbefore. Further, from this heuristic image interpretation the micro controller would generate a report of items in a mini-bar and/or items removed from the mini-bar. Again, this report can be printed, displayed, and/or archived.

A log of the images could be generated and stored at the central server. This log would be useful for analyzing anomalies or resolving disputes with guests at a later time. Further, the log could be useful to a mini-bar service company or a lodging corporation for data mining purposes and/or consumption interpretation and folio posting (ASP model). The log could be sent directly to a mini-bar service company or a lodging corporation over the Internet, as described herein.

If pictures/images are scheduled to be collected periodically, then such could be suspended when the room is not occupied. The central server has data as to the occupancy/rental status of a room, whereby it would send a command to the controller 25 to suspend collecting images. Controller 25 may be configured to provide an event message in response to some event. An event message may include the opening of a door to a mini-bar or that images have been obtained and are available, for example. Further, in a refrigerated mini-bar the level of cooling or the times the unit is run for cooling could be set, thereby providing energy savings. Such could be substantial in the larger multi-unit buildings.

FIG. 8 depicts a centralized room control system or network 70. System 70 may be of the type described in one or more of the following: International Application Serial No. PCT/US02/02354, filed on Jan. 24, 2002; International Patent Application Serial No. PCT/US02/02264 filed on Jan. 24, 2002; U.S. patent application Ser. No. 10/470,111 filed on Jul. 23, 2003; U.S. patent application Ser. No. 10/470,109 filed on Jul. 23, 2003; U.S. Provisional Patent Application No. 60/263,940 filed on Jan. 24, 2001; U.S. Provisional Patent Application No. 60/323,872 filed on Sep. 21, 2001; all of which said applications are incorporated herein by reference. Building-level services such as, but not limited to, central electronic lock control, energy management, room control, and Internet access services may be provided to one or more rooms 10 throughout one or more hotels 72 (or other multi-unit building) over the same network. While the present example is directed to one or more hotels 72, it will be recognized that the system 70 has application in a wide range of multi-unit buildings including, but not limited to, universities, health care, multi-dwelling units (MDUs), office, resort, and residential.

As depicted in FIG. 8, the server 62 may be in communication with the Internet 78 by way of a modem 80, as is well known, or by wireless means, as is also well known, whereby the server 62 may be accessed remotely.

While the invention has been described with reference to preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best modes contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A mini-bar comprising:
an imaging device disposed for acquiring an image of an interior of the mini-bar.

2. The mini-bar of claim 1, further comprising a controller associated with the imaging device for controlling acquisition of the image.

3. The mini-bar of claim 2, wherein the controller is further configured to cause data indicative of the image to be communicated external of the mini-bar.

4. The mini-bar of claim 3, wherein the data is communicated wirelessly.

5. The mini-bar of claim 3, wherein the mini-bar comprises a refrigerated mini-bar and wherein the controller is configured to adjust a temperature of the mini-bar in response to at least one of the image data and a signal communicated from external of the mini-bar.

6. The mini-bar of claim 1, further comprising a light for illuminating the interior of the mini-bar, the light being illuminated at least when the image is acquired.

7. The mini-bar of claim 6, wherein the light comprises infrared light.

8. The mini-bar of claim 2, further comprising a switch to detect a state of a door of the mini-bar, the controller being in communication with the switch to prohibit acquisition of the image when the state of the door is open or to enable acquisition of the image when the state of the door is closed.

9. A system for monitoring activity of a mini-bar in a room of a multi-unit building, comprising:
an imaging device disposed for acquiring an image of an interior of the mini-bar, the imaging device configured to generate image data indicative of the image; and
a display device receptive to the image data for displaying the image, the display device configured for viewing the image external to the mini-bar.

10. The system of claim 9, wherein the display device is disposed outside of the room proximate an entry door associated with the room.

11. The system of claim 10, wherein the display device further includes a switch for enabling display of the image.

12. The system of claim 11, wherein the switch comprises a hidden switch.

13. The system of claim 9, further comprising a controller associated with the imaging device for controlling acquisition of the image.

14. The system of claim 9, wherein the imaging device is in communication with a network of the multi-unit building for providing the image data to the network.

15. The system of claim 14, wherein the mini-bar comprises a refrigerated mini-bar and wherein a controller of the mini-bar is configured to adjust a temperature of the mini-bar in response to at least one of the image data and a signal communicated from the network.

16. The system of claim 14, further comprising a processor in communication with the imaging device for receiving the image data, the processor processing the image data for display at the display device, the display device in communication with the processor.

17. The system of claim 16, wherein the processor processing the image data further comprises processing the image data to emphasize a difference from an image acquired previously.

18. The system of claim 17, wherein the difference comprises a removed item.

19. The system of claim 17, wherein the image comprises an infrared image, and the difference comprises a tampered item.

20. The system of claim 17, wherein the server processing the image data further comprises processing the image data to generate a report of items remaining in the mini-bar or of items removed from the mini-bar.

21. The system of claim 13, wherein the controller is further configured to wirelessly transmit the image data.

22. The system of claim 21, wherein the controller is further configured to wirelessly transmit utilizing infrared (IR).

23. The system of claim 21, wherein the controller is further configured to wirelessly transmit utilizing radio frequency (RF).

24. The system of claim 22, further comprising a gateway device located inside of the room for receiving the image data transmitted utilizing infrared and converting the image data for communication over wires.

25. The system of claim 21, wherein the display device comprises a portable communication device receptive of wireless communication.

26. The system of claim 25, wherein the portable communication device comprises a personal digital assistant (PDA).

27. A method for monitoring activity of a mini-bar in a room of a multi-unit building, comprising:
acquiring an image of an interior of the mini-bar; and
displaying the image.

28. The method of claim 27, further comprising processing the image to emphasize a difference from an image acquired previously.

29. The method of claim 28, wherein the difference comprises a removed item.

30. The method of claim 28, wherein the image comprises an infrared image, and the difference comprises a tampered item.

31. The method of claim 28, further comprising processing the image data to generate a report of items remaining in the mini-bar or of items removed from the mini-bar.

32. The method of claim 27, further comprising wirelessly transmitting the image.

33. The method of claim 32, wherein the wirelessly transmitting comprises wirelessly transmitting utilizing infrared (IR).

34. The method of claim 32, wherein the wirelessly transmitting comprises wirelessly transmitting utilizing radio frequency (RF).
